(19) United States
(12) Patent Application Publication
(10) Pub. No.: US 2025/0025899 A1
(43) Pub. Date: Jan. 23, 2025

(54) PARTICLE SPREADER WITH ENHANCED RATE CONTROL ASSEMBLY

(71) Applicant: Earthway Products, Inc., Bristol, IN (US)

(72) Inventors: Eric Vandiepenbos, New Paris, IN (US); Bill Bunch, New Paris, IN (US); Kevin R. Fulmer, Middlebury, IN (US); John Marshall, Granger, IN (US); Jose Jimenez, Elkhart, IN (US)

(21) Appl. No.: 18/779,908

(22) Filed: Jul. 22, 2024

Related U.S. Application Data
(60) Provisional application No. 63/514,715, filed on Jul. 20, 2023.

(51) Int. Cl. B05B 7/14

(52) U.S. Cl. CPC B05B 7/1413

(57) ABSTRACT

A particle spreader broadly comprising a hopper supported by a wheeled chassis, a rate plate, and a rate control gauge. The hopper presents a hopper discharge opening in fluid communication with a hopper chamber to permit flow of particles therefrom. The rate plate controls particle flow out of the hopper chamber and presents a plate discharge opening. The rate plate is shiftable between a closed position and a first open position in which the plate discharge opening is in at least partial registration with the hopper discharge opening. The rate control gauge is configured to engage the rate plate when the rate plate is in the first open position. The rate plate is biased toward the rate control gauge. The rate control gauge is adjustable to engage the rate plate when the rate plate is in a second open position.

### CROSS-REFERENCE TO RELATED APPLICATIONS

This regular utility non-provisional application claims priority benefit with regard to all common subject matter of U.S. Provisional Patent Application Ser. No. 63/514,715, filed Jul. 20, 2023, and entitled “Particle Spreader with Enhance Rate Control.” The provisional patent application is hereby incorporated by reference in its entirety into the present patent application.

### TECHNICAL FIELD

The present invention relates to a particulate dispersing apparatus and, more specifically, to a particle spreader with an enhanced rate control assembly.

### BACKGROUND OF THE INVENTION

Many different types of spreaders are used to spread or otherwise distribute particulate material (hereinafter “particles”) such as fertilizer, grass seed, salt, sand, ice melt, and the like onto surfaces such as lawns, golf courses, turf, sidewalks, parking lots, and the like. Manually operated spreaders are used in both residential and commercial applications, which include lawn fertilizing, weed control, ice control, seeding, and the like. These spreaders often have a hopper mounted on a wheeled frame and an adjustable control mechanism configured to selectively permit, as well as prevent, a discharge of particles from the hopper. The control mechanisms typically include a lever that a user may operate to switch the mechanism “on” (i.e. condition or state for the discharge of particles from the hopper) or “off” (i.e., condition or state for preventing the discharge of particles from the hopper). Some control mechanisms also include an adjustment gauge to control a flow rate at which particles are discharged from the hopper.

However, conventional residential and commercial particle spreaders have various deficiencies. For instance, known residential spreaders have control mechanisms that slowly or ineffectively switch between the “on” and “off” conditions and/or discharge particles at flow rates that are inaccurate or inconsistent with rate settings of the adjustment gauge. Additionally, even though known commercial spreaders have control mechanisms that provide improvements over residential spreaders, such commercial spreader control mechanisms are also problematic. For example, control mechanisms of known commercial spreaders are complex and include numerous components, such as linkages, pivot points, interconnections, springs, and the like. An arrangement of these components, including their attachment at portions of other components prone to flexing, like a plastic hopper side wall, produces a tolerance “stack-up” for the overall mechanism, and as a result, control mechanisms of commercial spreaders have inefficient constructions that cause inaccuracies, are difficult to maintain, and are expensive to manufacture.

The background discussion is intended to provide information related to the present invention which is not necessarily prior art.

### BRIEF SUMMARY OF THE INVENTION

The instant invention is generally directed to a particle spreader with an enhanced rate control assembly that overcome the deficiencies of the spreaders discussed above.

A first embodiment is a particle spreader broadly comprising a wheeled chassis, a hopper supported by the wheeled chassis, a rate plate shiftably supported near the hopper, and a rate control gauge attached to the hopper. The hopper defines a hopper chamber for receiving particles and presents a hopper discharge opening in fluid communication with the hopper chamber to permit flow of particles out of the hopper chamber. The rate plate controls particle flow out of the hopper chamber and presents a plate discharge opening. The rate plate is shiftable between a closed position in which the rate plate covers the hopper discharge opening and a first open position in which the plate discharge opening is in at least partial registration with the hopper discharge opening to permit particle flow out of the hopper chamber. The rate control gauge is configured to engage the rate plate when the rate plate is in the first open position. The rate plate is biased toward the rate control gauge. The rate control gauge is adjustable to engage the rate plate when the rate plate is in a second open position.

Another embodiment is a particle spreader broadly comprising a wheeled chassis, a hopper coupled to and supported by the wheeled chassis, a rate control gauge attached to the bottom of the hopper, and a rate plate. The hopper comprises one or more hopper discharge openings near its bottom. The rate control gauge comprises a gauge plate and a stop repositionable along the gauge plate at a series of stop positions. The rate plate comprises one or more discharge openings and is movable relative to the rate control gauge between a closed position and one of first and second open positions. The rate plate fully covers the one or more hopper discharge openings when the rate plate is in the closed position. The rate plate abuts the stop and the one or more plate discharge openings is in at least partial registration with the one or more hopper discharge openings when the rate plate is in the first open position or the second open position.

Yet another embodiment is a method of operating a particle spreader with a rate control assembly. The method comprises a step of shifting a rate plate between a closed position in which particles are held within a hopper and a first open position in which the particles are released through a discharge opening of the hopper at a first flow rate. The method further comprises steps of releasing a stop from a gauge plate and moving the stop along the gauge plate from a first stop position to a second stop position. The method further comprises steps of releasably securing the stop to the gauge plate at the second stop position and shifting the rate plate between the closed position and the second open position in which the particles are released through the discharge opening of the hopper at the second flow rate.

These and other features will be discussed in more detail in connection with the accompanying drawings.

### BRIEF DESCRIPTION OF THE SEVERAL VIEWS OF THE DRAWINGS

The present invention is described in detail below with reference to the attached drawing figures, wherein:

FIG. 1 is a front perspective view of a particle spreader with enhanced flow rate control according to one embodiment of the invention;

FIG. 2 is a rear perspective view of the spreader of FIG. 1;

FIG. 3 is a top perspective view of the spreader of FIG. 1;

FIG. 4 is a perspective view of certain components of the spreader of FIG. 1;

FIG. 5 is a bottom plan view of certain components of the spreader of FIG. 1;

FIG. 6 is a perspective view of certain components of the spreader of FIG. 1;

FIG. 7 is a bottom plan view of certain components of the spreader of FIG. 1;

FIG. 8 is a perspective view of certain components of the spreader of FIG. 1;

FIG. 9 is a bottom plan view of certain components of the spreader of FIG. 1;

FIG. 10 is a bottom plan view of certain components of the spreader of FIG. 1;

FIG. 11 is an exploded view of certain components of the spreader of FIG. 1;

FIG. 12 is a perspective exploded view of portions of the spreader of FIG. 1;

FIG. 13 is a perspective view of certain components of the spreader of FIG. 1;

FIG. 14 is a perspective view of certain components of the spreader of FIG. 1;

FIG. 15 is a perspective view of certain components of the spreader of FIG. 1;

FIG. 16 is a bottom perspective view of a component of the spreader of FIG. 1;

FIG. 17 is a perspective view of a component of the spreader of FIG. 1;

FIG. 18 is a bottom perspective view of a component of the spreader of FIG. 1;

FIG. 19 is a perspective view of a component of the spreader of FIG. 1;

FIG. 20 is a perspective view of a component of the spreader of FIG. 1;

FIG. 21 is a bottom perspective view of a component of the spreader of FIG. 1;

FIG. 22 is a bottom perspective view of a component of the spreader of FIG. 1; and

FIG. 23 is a perspective view of a component of the spreader of FIG. 1.

### DETAILED DESCRIPTION OF THE INVENTION

At a high level, the subject matter of this application generally relates to walk-behind spreaders and other spreaders used to distribute particles such as fertilizer, grass seed, and other grass treatments on lawns, golf courses, and other turf, or used to distribute particles such as salt, sand, ice melt, and others on a variety of surfaces. This application is particularly directed to a spreader including an innovative rate control assembly for regulating a material flow rate and instantaneously switching the material flow rate on and off to tailor the particle spreader to the specific task at hand. These features will become more readily apparent in the following discussion.

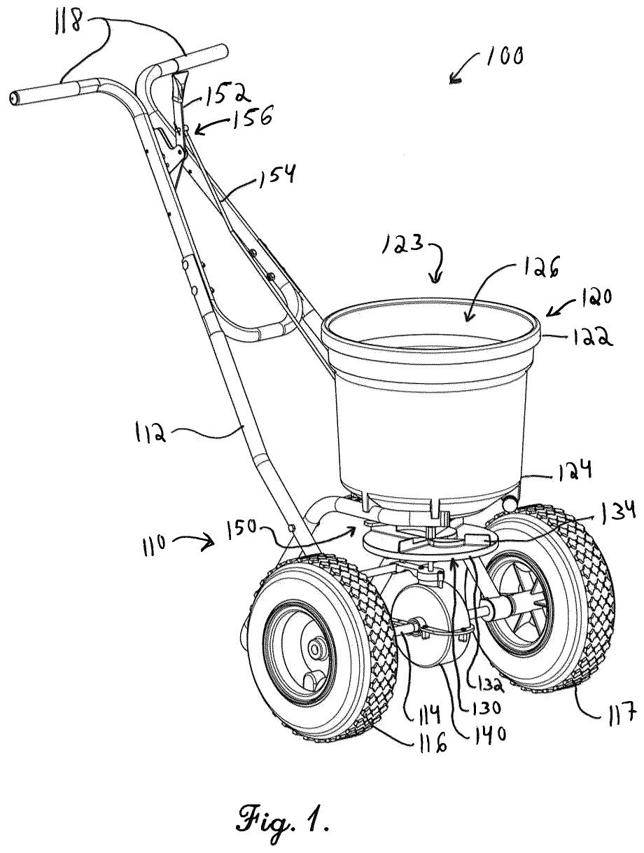

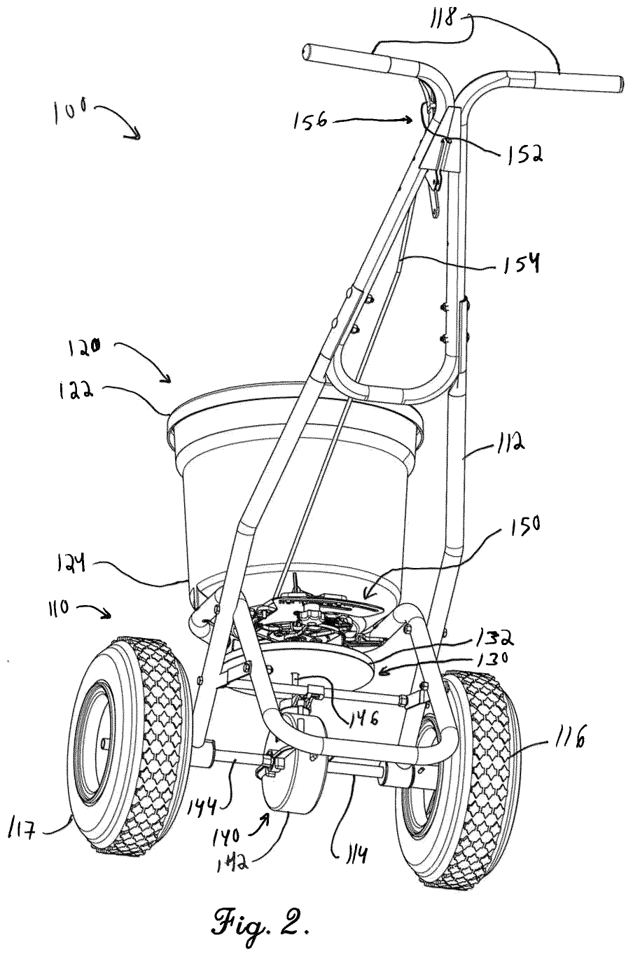

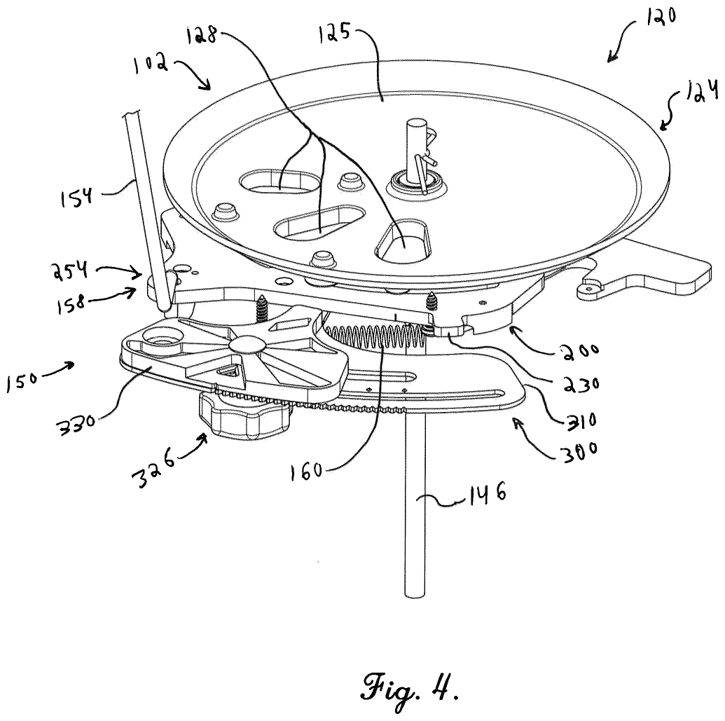

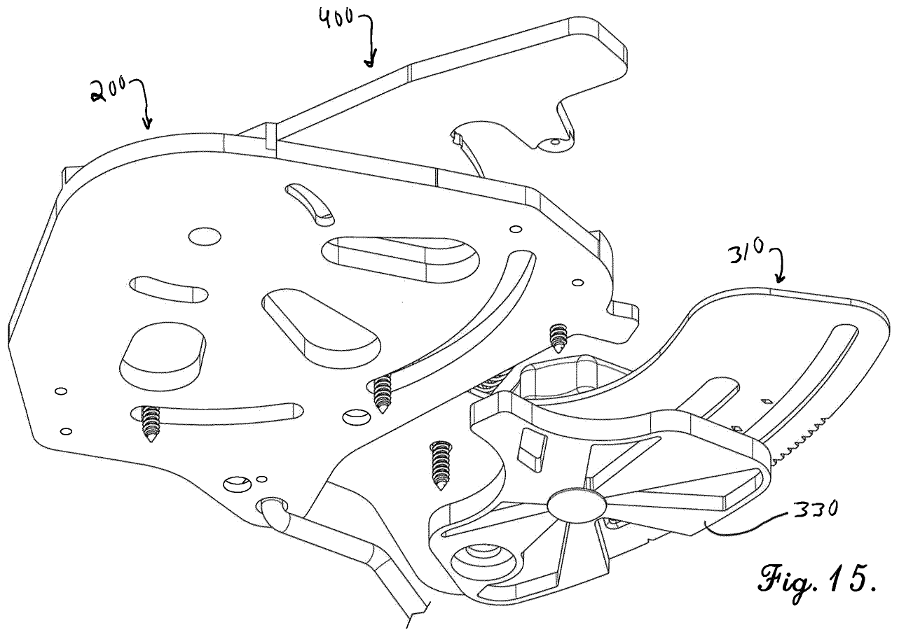

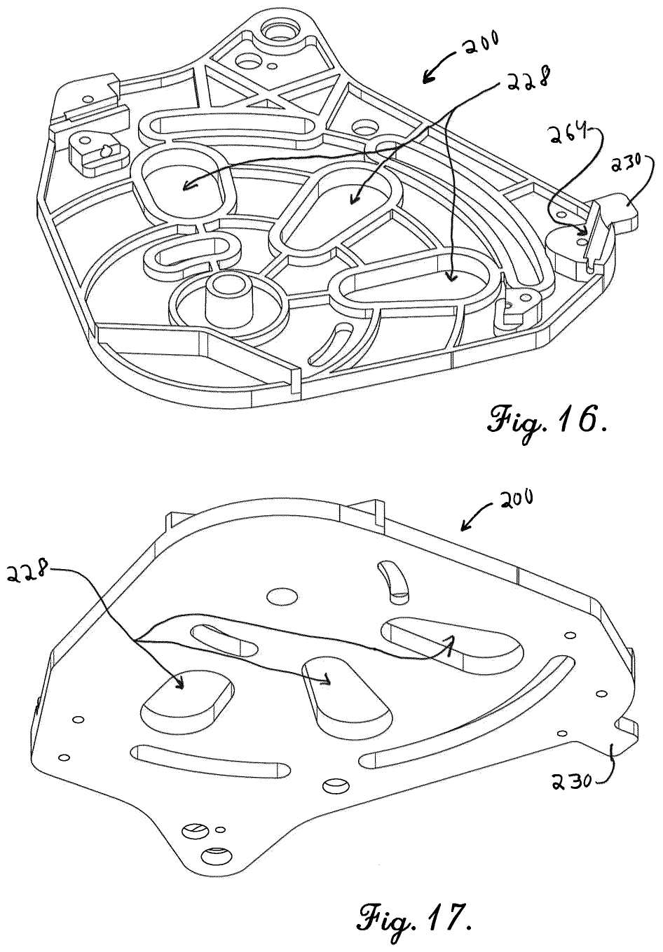

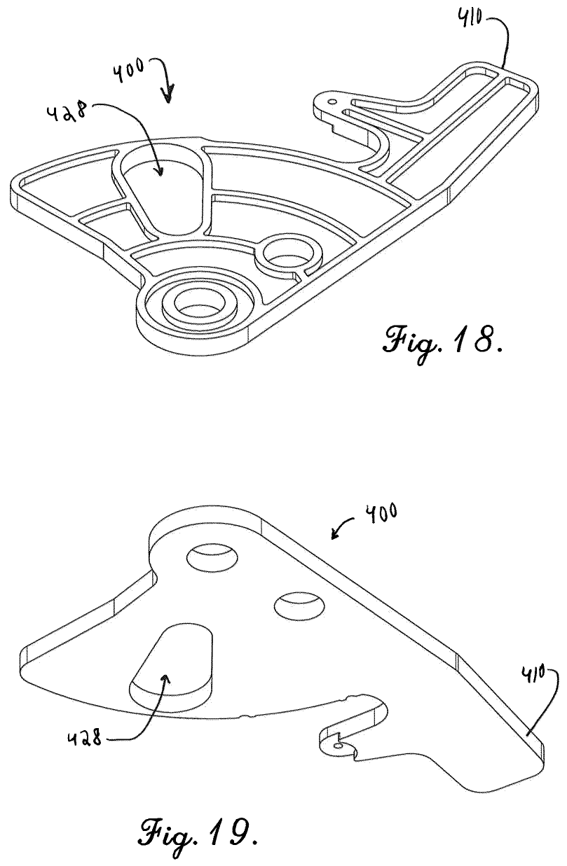

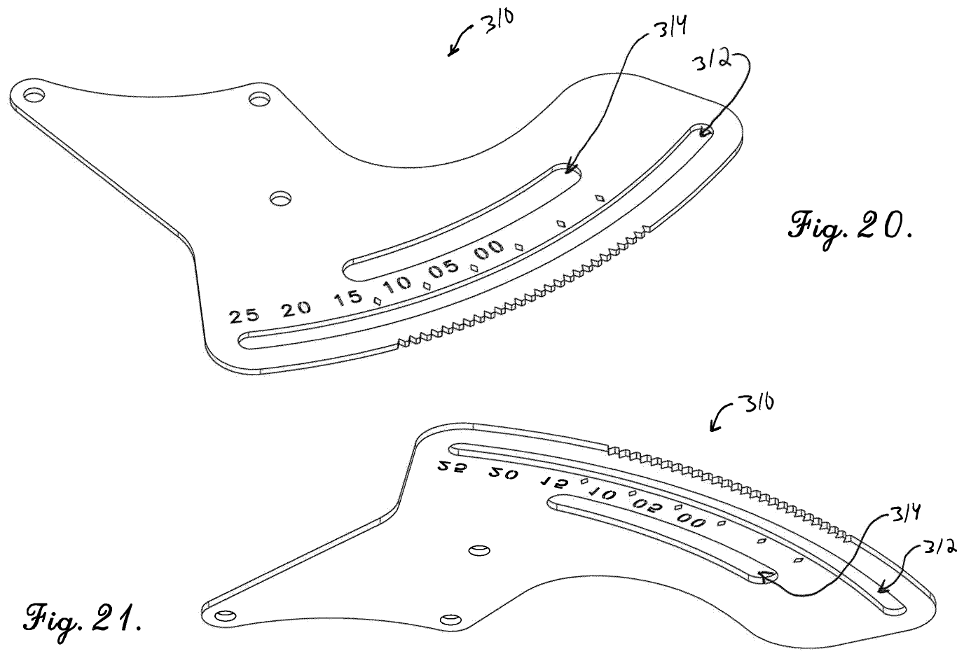

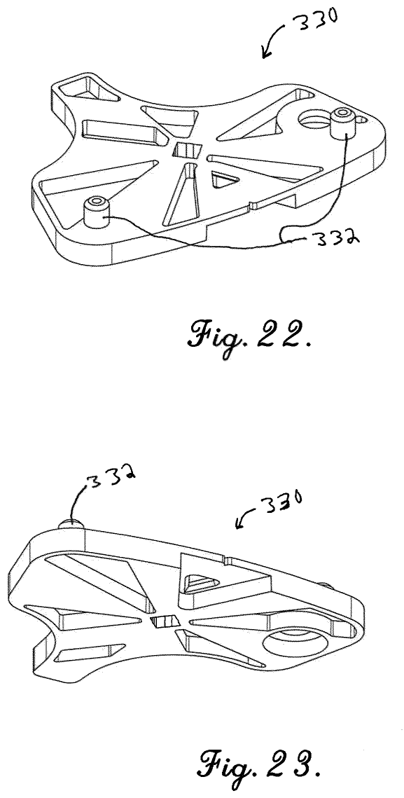

FIGS. 1-3 show a particle dispersing apparatus (hereinafter “particle spreader 100”) according to some aspects of the invention. FIGS. 4-10 show various aspects related to a rate control assembly 150 of the particle spreader 100. FIGS. 11-19 show individual components of the rate control assembly 150 in greater detail. The particle spreader 100 may be any type of particulate dispersing apparatus capable of dispersing particles such as but not limited to lawn seed or fertilizer, salt, sand, ice melt, and other material. The particle spreader 100 is depicted as a walk behind spreader and may be manually advanced by a user to discharge a uniform and continuous flow of particles onto the ground and/or manufactured surface. However, in other embodiments, the features described herein could be employed on other types of particulate dispersing apparatuses including, for example, a hand-held spreader and a tow-type spreader, single or dual impeller spreaders, ground-driven spreaders, independent drive spreaders, among others.

The particle spreader 100 broadly includes a wheeled chassis 110, a hopper 120, a rotor 130, a rotor drive 140, and a rate control assembly 150. The wheeled chassis 110 may be configured to support the hopper 120 and a volume of particles within the hopper 120. The wheeled chassis 120 may include a frame 112, an axle 114 extending between a drive wheel 116 and an idler wheel 117, and a handle 118 attached to and located rearwardly of the frame 112. The handle 118 may be configured to be grasped by a user to manually advance the particle spreader 100 during operation.

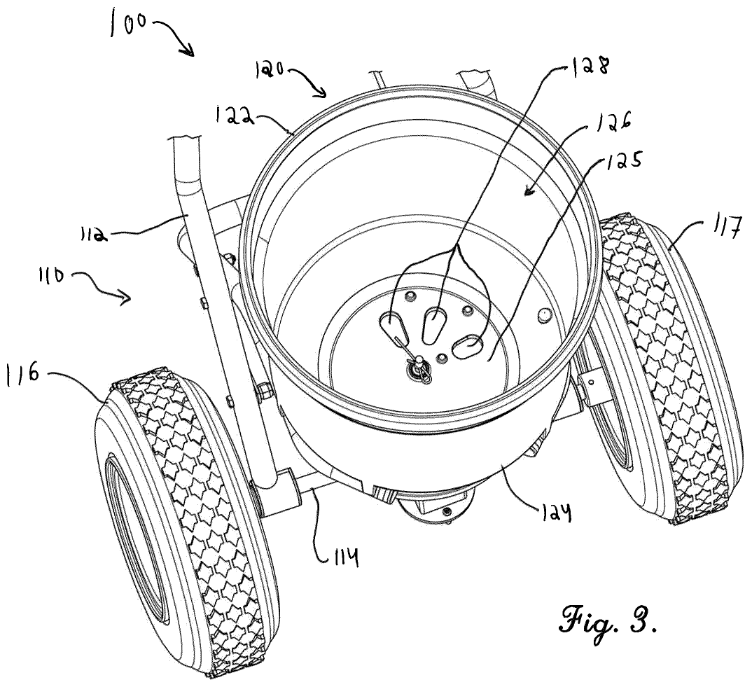

The hopper 120 may be supported by the wheeled chassis 110 and may be a unitary container that extends vertically between an upper end 122 and a lower end 124 to define a hopper chamber 126 configured to hold particles for spreading. The hopper 120 may further include an open top 123 near the upper end 122 that permits a user to selectively fill and/or empty the hopper chamber 126. Further, as shown in FIG. 3, the hopper 120 may include one or more hopper discharge openings 128 at a bottom 125 of the hopper 120 near the lower end 124, which communicate with the hopper chamber 126 and permit flow of particles out of the hopper chamber 126 via gravity.

The rotor 130, also referred to as an impeller, may be located below the one or more discharge openings 128 of the hopper 120 and may be configured to receive a flow of particles from the hopper 120 and then cast the particles outwardly from the particle spreader 100. The rotor includes 130 may include a rotor plate 132 and a plurality of vanes 134 integrally formed with the rotor plate 132. The plurality of vanes 134 may be upright and extend radially outwardly relative to a rotor axis. The rotor plate 132 and the plurality of vanes 134 may be configured to collect the particles as they are released from the hopper 120 and fall onto the rotor plate 132 and then propel the particles radially outwardly from the particle spreader 100.

The rotor drive 140 may be configured to power the rotor 130 as the particle spreader 100 is advanced along the ground. In the depicted example, the rotor drive 140 includes a transmission (not shown), a transmission housing 142, and a drive shaft 144, and a driven shaft 146 attached to the rotor 130. The transmission may be positioned within the transmission housing 142 and includes and a right-angle gear drive (not shown), which may be positioned and operably located within the transmission housing. The drive shaft 144 of the axle 114 may be drivingly attached to the drive wheel 116 and to an input gear (not shown) of the transmission. The driven shaft 146 may be drivingly attached to an output gear (not shown) of the transmission and the rotor 130, which may also be drivingly mounted on the driven shaft 146 to rotate therewith. In example aspects, an axis of the axle 114 and an axis of the driven shaft 146 are coaxial with one another. Thus, as the drive wheel rotates (e.g., due to advancement of the particle spreader), the rotor drive 140 causes corresponding rotation of the rotor 130.

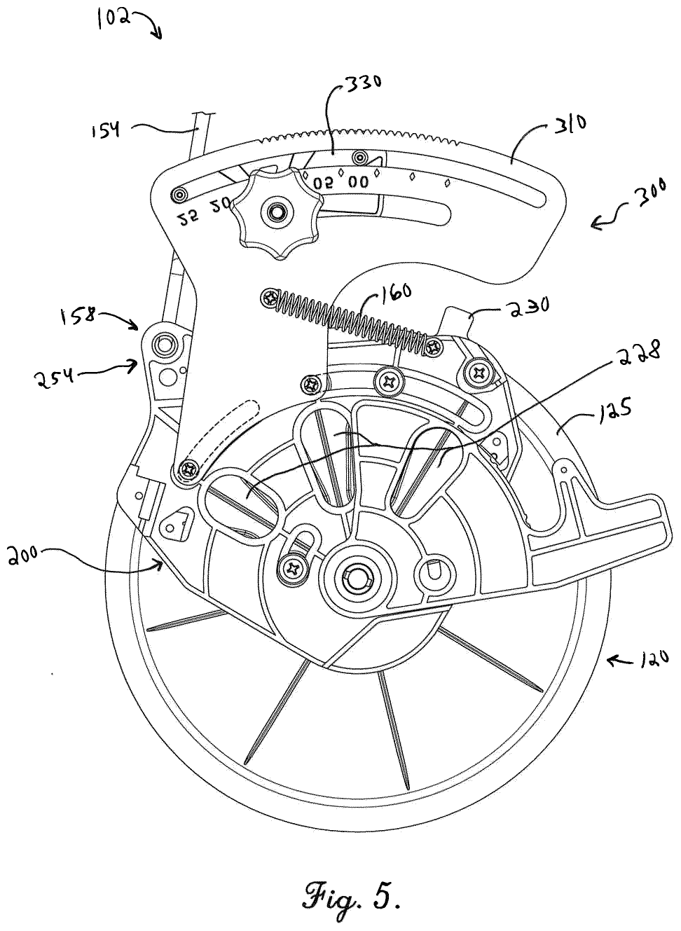

With further reference to FIGS. 4 and 5, the rate control assembly 150 may include a rate control lever 152, a linkage 154, a rate plate 200, and a rate control gauge 300. At a high level, the rate control assembly 150 and the components thereof may be configured to permit regulation of a material flow rate and instantaneously switch the material flow rate on and off. That is, the rate control assembly 150 may be operated to adjust a flow of particles through the one or more hopper discharge openings 128 and to shift the rate plate 200 between first and second open positions 104, 106 and a closed position 102. The rate plate 200 may be shiftably supported near the hopper 120 to control particle flow out of the hopper 120 and may present a plurality of plate discharge openings 228. The rate plate 200 may be mounted for movement and/or shifting (e.g., rotation or translation) relative to the hopper 120. The rate plate 200 may obstruct the one or more hopper discharge openings 128 at the bottom 125 of the hopper 120 and thereby meter out a percent and/or change a registration of the one or more plate discharge openings 228 with the one or more hopper discharge openings 128 from 0% (e.g., closed) to 100% (e.g., fully open). In example aspects, the rate plate 200 may be shiftable between the closed position 102, shown in FIGS. 3-5, in which the rate plate 200 fully covers the one or more hopper discharge openings 128 (e.g., 0% open) and the first and second open positions 104, 106, as shown in FIGS. 6-9, in which the one or more plate discharge openings 228 are in at least partial alignment with the respective one or more hopper discharge openings 128 to permit flow of particles out of the hopper chamber 126.

The rate control gauge 300 broadly comprises a gauge plate 310, a stop 330, and a locking device 326. The rate control gauge 300 may be used to dictate the open position of the rate plate 200 and hence the flow rate of the particle spreader 100.

The gauge plate 310 may be secured to the hopper 120 via fasteners 321. The gauge plate 310 may include a curved slotted opening 314 for receiving the locking device 326 and a guide slot 312 for receiving guides 332 of the stop 330. The gauge plate 310 may also include a spring fastener opening 361 and markings or indicia for indicating a selected flow rate.

The stop 330 may be selectively shiftable relative to the gauge plate 310 and may include the aforementioned guides 332 configured to be moved along the guide slot 312. The stop 330 may be configured to engage the rate plate 200 and may be connected thereto via a biasing element such as spring 160.

The locking device 326 may include an adjustment knob 340 having a fastener opening 344 and a fastener 334 (integrated with the stop 330 in one embodiment). The locking device 326 may be configured to selectively secure the stop 330 to the gauge plate 310. The locking device 326 may alternatively be a clip, pin, set screw, or the like. The fastener 334 may be a threaded bolt and the fastener opening 344 of the adjustment knob 340 may be threaded to accommodate the threaded bolt. The adjustment knob 340 may be located on one side of the gauge plate 310 and the stop 330 may be located on the other side of the gauge plate 310. The adjustment knob 340 may be configured to be removably held in frictional engagement with the gauge plate 310.

The rate control lever 152, the linkage 154, the rate plate 200, and the rate control gauge 300 will now be discussed in connection with open and closed configurations of the rate plate 200. With reference to FIGS. 4 and 5, which respectively show top and bottom views of the rate control assembly 150 and the bottom 125 of the hopper 120, the rate plate 200 is shown in the closed position 102. As such, the one or more plate discharge openings 228 fully cover the one or more hopper discharge openings 128, and therefore, in this configuration (e.g., the closed position 102), particles are not permitted to be and/or are not released from the hopper chamber 126. Additionally, a spring 160, which operably connects the rate plate 200 and the rate control gauge 300 may be in an elongated state, and a stop 330 of the rate control gauge 300 and a flange 230 of the rate plate 200 may be spaced apart.

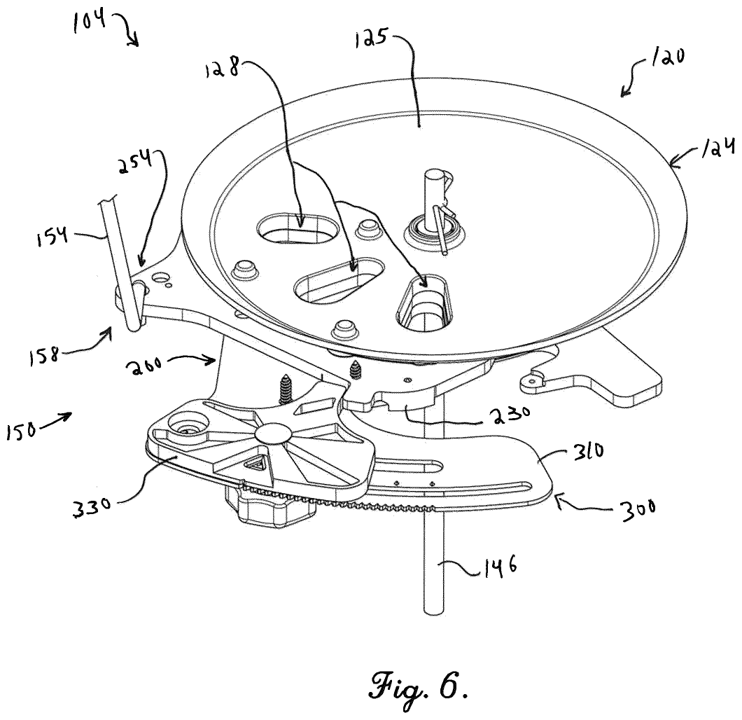

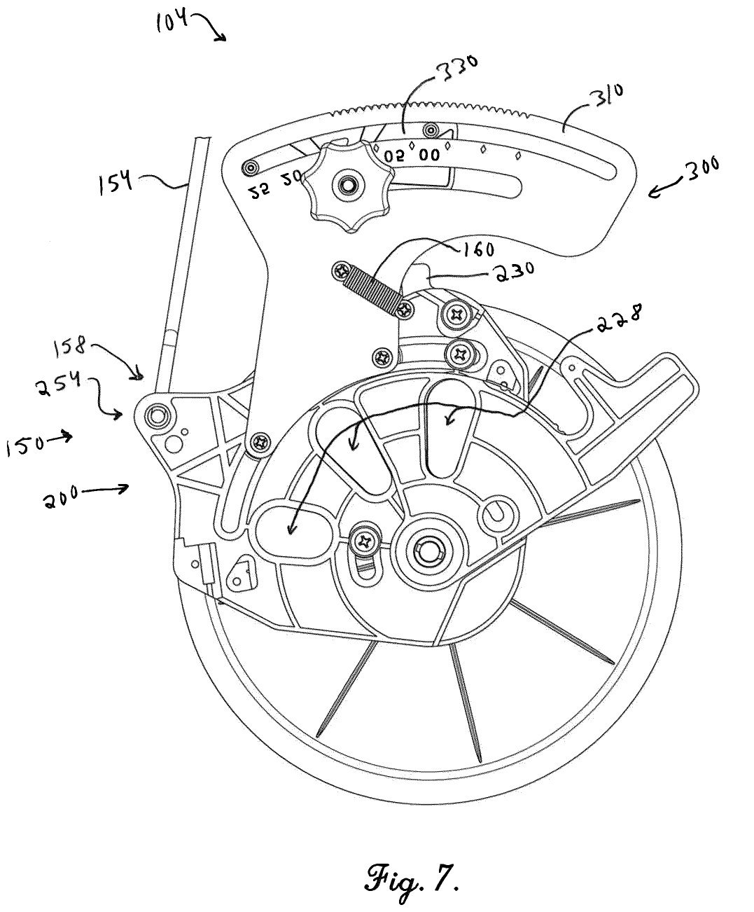

In contrast, and with reference now to FIGS. 6 and 7, which respectively show top and bottom views of the rate control assembly 150 and the bottom 125 of the hopper 120, the rate plate 200 is shown in the first open position 104. Accordingly, the one or more plate discharge openings 228 are fully aligned (e.g. overlap, 100 percent registration) with the one or more hopper discharge openings 128. Thus, in this configuration (e.g., the first open position 104), particles are permitted to be and/or are released from the hopper 120 or the hopper chamber 126. Additionally, the spring 160 may be in a retracted state and biases the rate plate 200 toward the rate control gauge 300. Further, the stop 330 of the rate control gauge 300 and the flange 230 of the rate plate 200 are abutting one another. Notwithstanding, a position of the stop 330 (hereinafter “stop position”) along a gauge plate 310 of the rate control gauge 300 may be the same with the rate plate 200 in the closed position 102 of FIGS. 4 and 5 and in the first open position 104 of FIGS. 6 and 7.

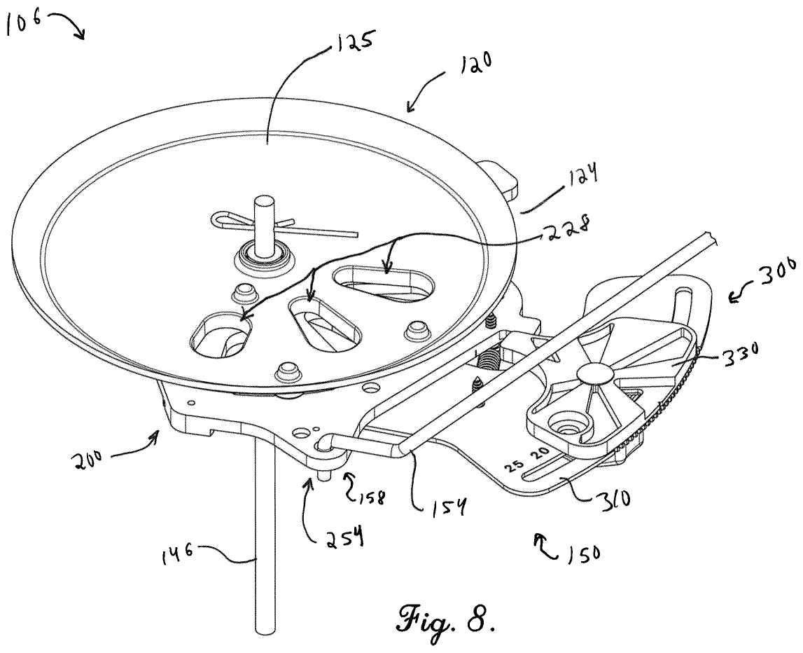

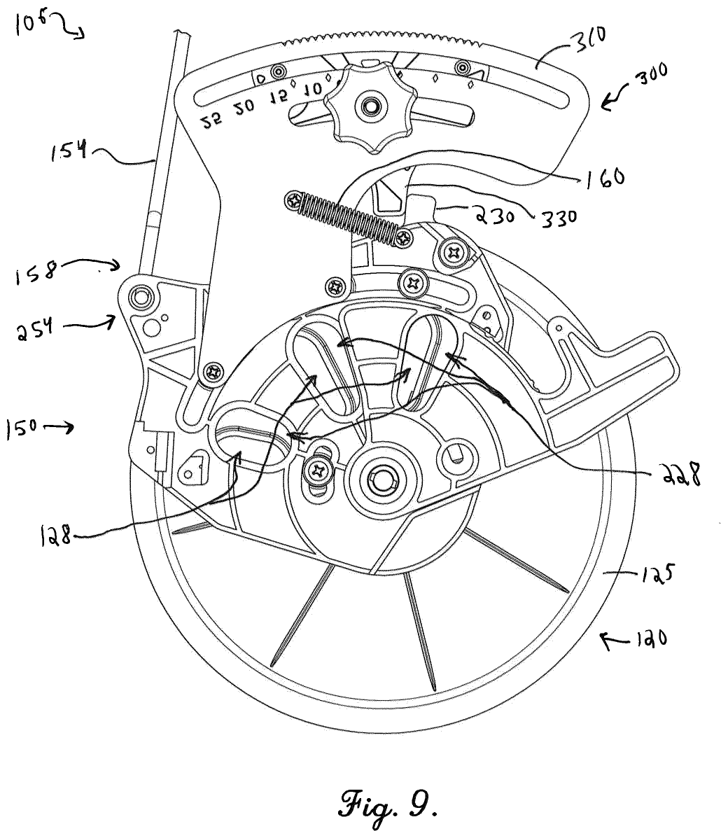

Turning now to FIGS. 8 and 9, which respectively show top and bottom views of the rate control assembly 150 and the bottom 125 of the hopper 120, the rate plate 200 is shown in an adjusted open position (second open position 106) in which the one or more plate discharge openings 228 are partially aligned (e.g. partially overlap, less than 100 percent registration) with the one or more hopper discharge openings 128. As such, in this configuration (e.g., the adjusted open position 106), particles are permitted to be and/or are released from the hopper 120 or the hopper chamber 126 at a flow rate that is less than a flow rate corresponding to the first open position 104. Additionally, the spring 160 may be in a partially retracted state, and even though the rate plate 200 is being biased toward the rate control gauge 300, an abutment of the stop 330 and the flange 230 prevents the rate plate 200 from further movement to the first open position 104. Further, a stop position of the stop 330 along the gauge plate 310 of the rate control gauge 300 may be associated with the second open position 106 and may be different than its stop position associated with the rate plate 200 in the first open position 104 of FIGS. 6 and 7.

In example aspects and with reference to FIGS. 1, 2, and 4-7, the rate control lever 152 may be shiftably (e.g., pivotally) supported near the handle 118 and may be operably associated with the rate plate 200. The linkage 154 may be attached to and may operably interconnect the rate plate 200 and rate control lever 152. That is, at first linkage end 156, the linkage 154 joins with the rate control lever 152, and at a second linkage end 158, the linkage joins with the rate plate 200. More specifically, at the second linkage end 158, the linkage 154 may be affixed to the rate plate 200 at a linkage point 254. Thus, forward and aft pivoting of the rate control lever 152 may cause movement (e.g., rotation or translation) of the rate plate 200 between the closed position 102 and the first open position 104, as well as between the closed position 102 and the second open position open 106. In other examples, the rate control assembly 150 may include an alternative mechanism for operably connecting the rate plate 200 and the rate control lever 152, such as an alternative linkage, such as where the rate control lever 152 movement is translated through a fixed pivot point to create a second, shorter in length control lever attached to the rate plate 200. The rate control lever 152 may also be operably associated with the rate plate 200 via a physical element other than a linkage, such as a flexible cable. Yet further, an alternative spreader may have a powered motor (such as an electric motor) for shifting the rate plate 200 open or closed in the similar open or closed positions. In such embodiments, the alternative spreader may be provided with a user control that communicates electronically with the motor (e.g., via a wired or wireless connection).

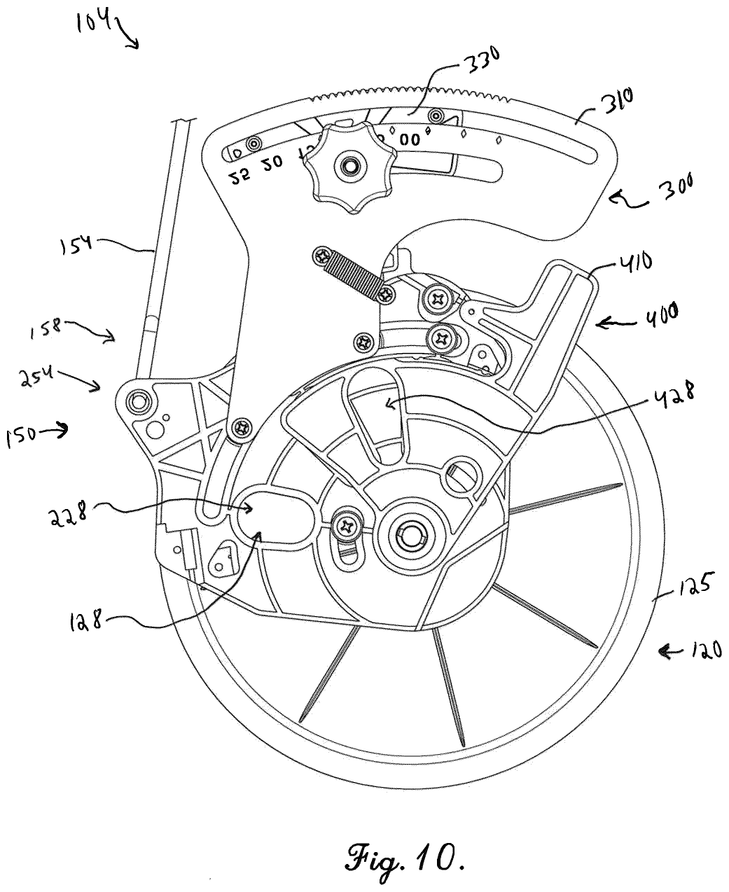

Turning to FIG. 10, the rate control assembly 150 may further comprise a spread control mechanism 400 including a pivot opening 446, a spread control opening 428, a handle 410, and a cable attachment point 402. The spread control mechanism 400 may be pivotably connected to the driven shaft 146 via the pivot opening 446 so that the spread control mechanism 400 blocks at least one of the plate discharge openings 228 when the spread control mechanism 400 is in a blocking position (see FIG. 10) and so that the spread control opening 428 is at least partially aligned with one of the plate discharge opening 228 when the spread control mechanism 400 is in a non-blocking position (see FIG. 9). The handle 410 allows a user to pivot the spread control mechanism 400 between the blocking position and the non-blocking position. The cable attachment point 402 receives the end of an adjustment cable (not shown) for moving the spread control mechanism 400 from an adjustment control near the handle 118 of the particle spreader 100. The adjustment cable may be supported by and aligned with the cable attachment point 402 via a cable guide 264 of the rate plate 200.

Turning to FIGS. 11 and 12, attachment between the hopper 120, the rate plate 200, the gauge plate 310, and the spread control mechanism 400 will now be described. The rate plate 200 may be positioned below the bottom 125 of the hopper 120 with the pivot opening 246 of the rate plate 200 aligned with the axle opening 147 of the hopper 120 on the driven shaft 146. The rate plate 200 may include inner slots 226 and outer slots 224 for accommodating fastener bosses 222, 322 of the hopper 120 and corresponding fasteners 221, 321. Fasteners 221 extend through some of the inner slots 226 and outer slots 224 into the fastener bosses 222 to support the rate plate 200 and to prevent the rate plate 200 from pivoting beyond a range defined by the inner slots 226 and outer slots 224.

The gauge plate 310 may be positioned below the rate plate 200 and secured to the hopper 120 via fasteners 321 inserted into fastener bosses 322. To that end, the fasteners 321 extend through the outer slots 224 so that the rate plate 200 can pivot.

The spread control mechanism 400 may be positioned below the rate plate 200 with the pivot opening 446 of the spread control mechanism 400 aligned with the axle opening 147 of the hopper 120 and the pivot opening 246 of the rate plate 200 on the driven shaft 146. The spread control mechanism 400 may pivot with the rate plate 200 unless independently activated via the handle 410 or a control cable.

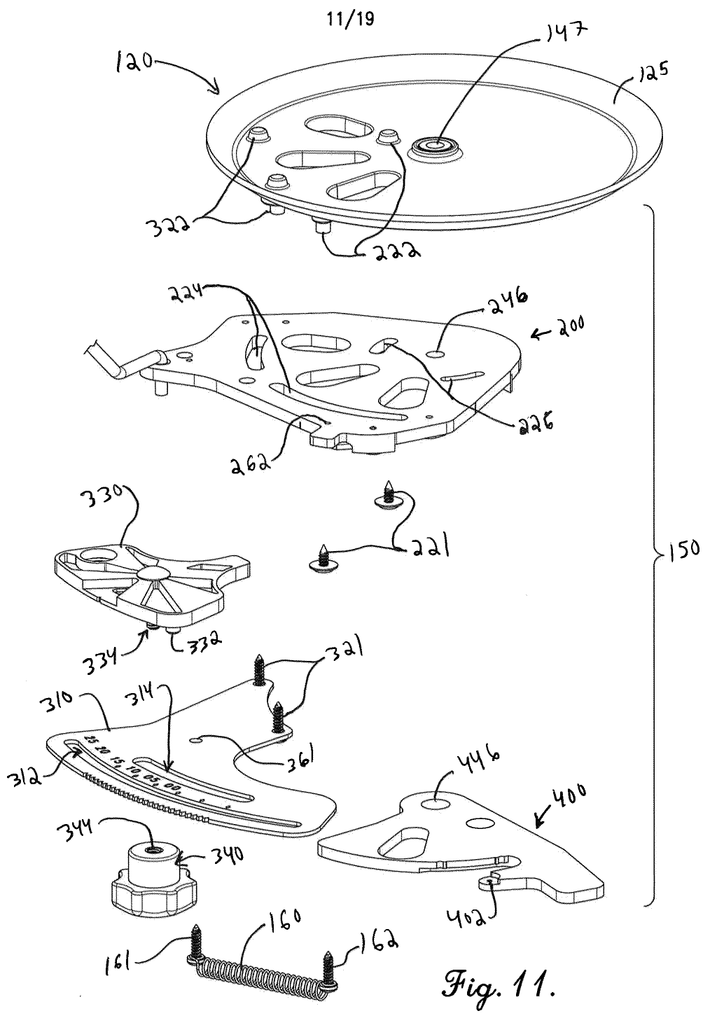

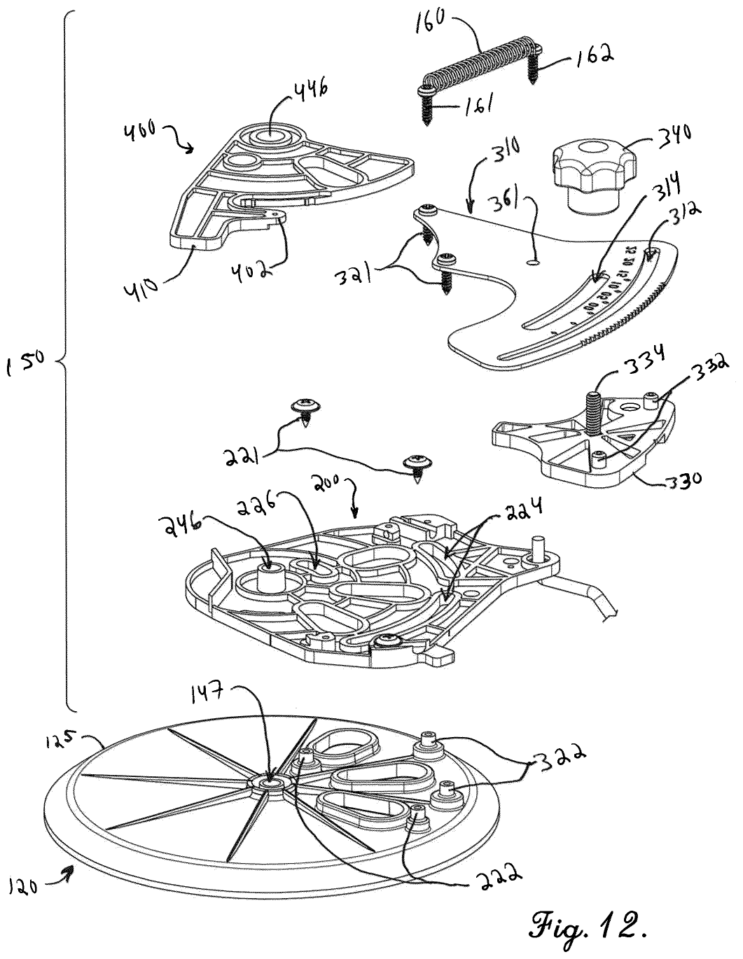

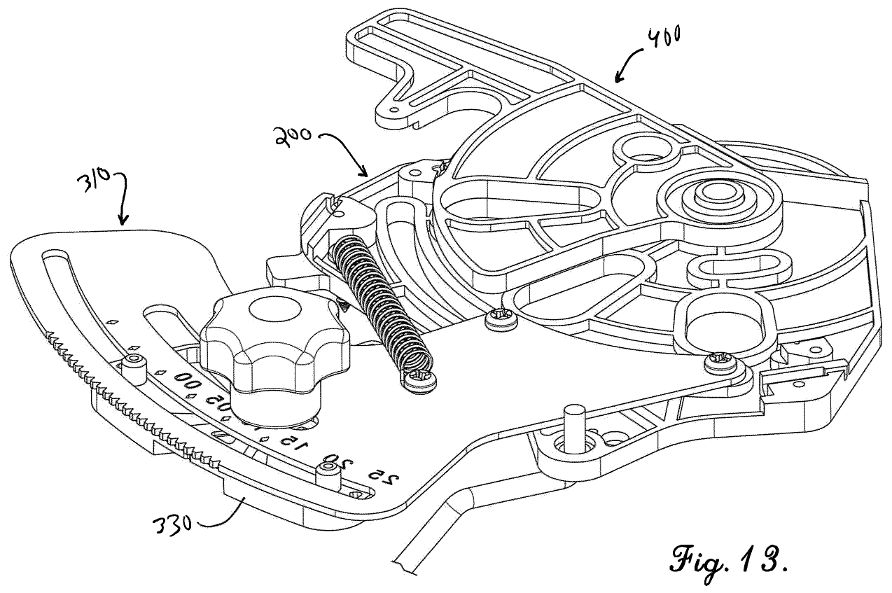

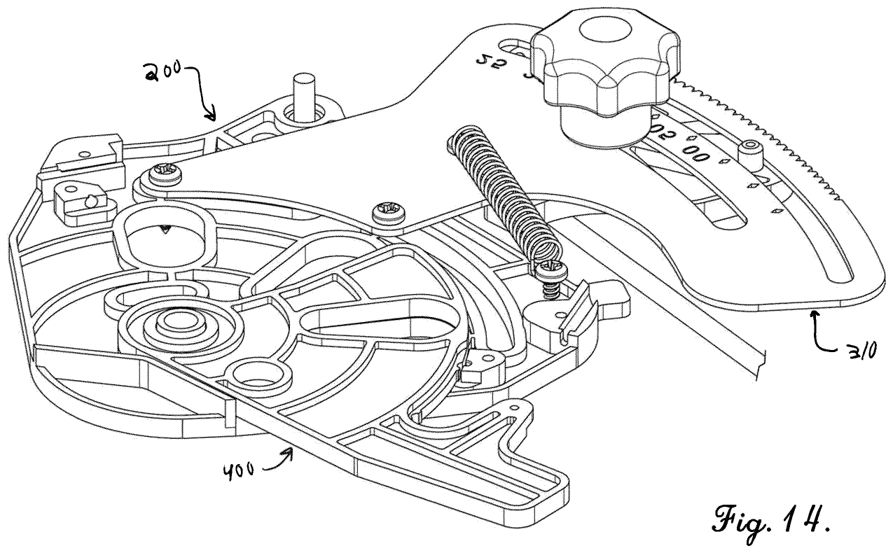

Turning to FIGS. 13 and 14, regarding the rate plate 200, the one or more plate discharge openings 228 may have a size and shape substantially identical to a size and shape of the hopper one or more discharge openings 128. Furthermore, the rate plate 200 may be configured to be moved into and out of a fully open position (first open position 104) in which the one or more plate discharge openings 228 are aligned and in full registration with the respective one or more hopper discharge openings 128. The rate plate 200 may include three of the one or more plate discharge openings 228, and at least two of the three one or more plate discharge openings 228 may be differently shaped from one another, while at least two of the three of the one or more plate discharge openings 228 may be substantially identically shaped. The two substantially identically shaped plate discharge openings may be near one another and may be elongated openings with one end being wider than the other/opposite end. The one differently shaped plate discharge opening may be elongate but shorter in length than the two substantially identically shaped plate discharge openings. Despite what is depicted in the example shown, it is contemplated that the one or more plate discharge openings 228 and/or the one or more hopper discharge openings may have any shape and/or size suitable for dispersing particles in accordance with aspects herein.

As best seen in FIGS. 7 and 9, the rate control gauge 300 adjustably engages the rate plate 200 via the stop 330 of the gauge plate 310 and the flange 230 of the rate plate 200 to restrict the rate plate 200 to various open positions such as the second open position (e.g., preventing the rate plate 200 from reaching the first open position 104). The rate plate 200 and rate control gauge 300 are operably associated with the spring 160 that urges the rate plate 200 toward the rate control gauge 300, or more specifically toward the gauge plate 310. In effect, the spring 160 urges the rate plate 200 toward one of the open positions (e.g., first open position 104 or second open position 106) as dictated by the stop position of the stop 330.

In the depicted embodiment, the gauge plate 310 of the illustrated rate control gauge 300 may be rigidly attached to the hopper 120 with fasteners 321. In another embodiment, the gauge plate 310 could be directly and rigidly attached to the frame 112. The gauge plate 310 may have a unitary construction and may be secured to the hopper 120 and/or frame 112 so that the rate plate 200 may slidably engage the gauge plate 310. The illustrated gauge plate 310 may be positioned at least partly below the rate plate 200, with the rate plate 200 resting on a generally planar guide surface 316 of the gauge plate 310. It is also within the scope of the present invention for the rate plate 200 to be alternatively supported relative to the gauge plate 310.

The guide surface 316 of the depicted gauge plate 310 also slidably abuts the stop 330. The gauge plate 310 presents curved slotted openings 314 to facilitate adjustable positioning of the stop 330. However, the gauge plate 310 may be alternatively shaped or otherwise alternatively configured to facilitate positioning and adjustment of the stop 330. The gauge plate 310 may also include markings or indicia that represent flow rates corresponding to the various stop positions of the stop 330.

In the depicted embodiment, the stop 330 may be adjustably slidably supported on the guide surface 316 of the gauge plate 310 to removably engage the rate plate 200 in one of the open positions (e.g., first or second open positions 104, 106), with the stop 330 being repositionable along the gauge plate 310 at one of a set of stop positions to set the open position and change the corresponding particle flow rate associated with the set open position.

The spring 160 may be attached to the rate plate 200 and the rate control gauge 300 via fasteners 161, 162 inserted into fastener holes 361 and 262 of the gauge plate 310 and the rate plate 200, respectively. The spring 160 thereby extends therebetween to urge the rate plate 200 toward the stop 160 (see FIGS. 7-10). The spring 160 may comprise a coiled tension spring. However, an alternative biasing element may be used to urge the rate plate 200 toward the stop 330. For at least some aspects of the present invention, the particle spreader 100 may not include a spring that urges the rate plate 200 open.

Embodiments of the present invention can be incorporated into a variety of configurations of spreaders, including spreaders constructed in accordance with the teachings of U.S. Pat. No. 10,993,368B2 to Earth Way Products Inc, incorporated by reference in its entirety into the present application.

In use, the particle spreader 100 may first be prepped by pouring particles into the hopper chamber 126. The particle spreader 100 may then be advanced along a ground surface via handle 118. The rate plate 200 may then be shifted to the first open position 104 from the closed position 102, if it is not already in the first open position 104, so that particles drop to the rotor 130 and are dispersed by the vanes 134 in a spread pattern. If it is determined a new (e.g., lesser) flow rate is desired, the stop 330 may be loosened via adjustment knob 340 and the stop 330 may be shifted along the gauge plate 310 from its initial stop position corresponding to the first open position 104 to a new stop position corresponding to a new open position such as second open position 106. To that end, the rate plate 200 may be temporarily shifted to the closed position 102 before adjustment of the stop 330. The stop 330 may then be secured in the new stop position. The rate plate 200 may then be shifted until it contacts the stop 330 so that the rate plate 200 is in the new open position. The particle spreader 100 may then again be advanced along the ground surface with the particles being dispensed at the new flow rate.

### ADDITIONAL CONSIDERATIONS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims set forth in any subsequent regular utility patent application. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims included in any subsequent regular utility patent application a non are not intended to be construed under 35 U.S.C. § 112 (f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention.

Having thus described various embodiments of the invention, what is claimed as new and desired to be protected by Letters Patent includes the following:

1. A particle spreader comprising:
a wheeled chassis;
a hopper supported by the wheeled chassis, the hopper defining a hopper chamber for receiving particles, the hopper presenting a hopper discharge opening in fluid communication with the hopper chamber to permit flow of particles out of the hopper chamber;
a rate plate shiftably supported near the hopper to control particle flow out of the hopper chamber and presenting a plate discharge opening, the rate plate being shiftable between a closed position in which the rate plate covers the hopper discharge opening and a first open position in which the plate discharge opening is in at least partial registration with the hopper discharge opening to permit particle flow out of the hopper chamber; and
a rate control gauge attached to the hopper and configured to engage the rate plate when the rate plate is in the first open position,
wherein the rate plate is biased toward the rate control gauge, and
wherein the rate control gauge is adjustable to engage the rate plate when the rate plate is in a second open position.

2. The particle spreader of claim 1, further comprising a spring configured to bias the rate plate toward the rate control gauge.

3. The particle spreader of claim 1, further comprising:
a handle for maneuvering the particle spreader; and
a rate control lever positioned near the handle and operably associated with the rate plate,
wherein the rate control lever is configured to move the rate plate between the closed position and one of the first open position and the second open position.

4. The particle spreader of claim 3, further comprising a linkage operably interconnecting the rate plate and the rate control lever.

5. The particle spreader of claim 1, wherein the rate control gauge comprises a gauge plate affixed to the hopper.

6. The particle of claim 5, wherein the rate control gauge further comprises a stop positioned on the gauge plate at a first stop position such that the stop engages the rate plate when the rate plate is in the first open position.

7. The particle spreader of claim 6, wherein the first stop position corresponds to a flow rate associated with the first open position, wherein the stop is repositionable along the gauge plate to a second stop position corresponding to a flow rate associated with the second open position.

8. The particle spreader of claim 6, wherein the rate control gauge further comprises a locking device 326 configured to removably secure the stop to the gauge plate at one of the first stop position and the second stop position.

9. A particle spreader comprising:
a wheeled chassis;
a hopper coupled to and supported by the wheeled chassis, the hopper comprising one or more hopper discharge openings at a bottom of the hopper;
a rate control gauge attached to the bottom of the hopper, the rate control gauge comprising:
a gauge plate; and
a stop repositionable along the gauge plate at a series of stop positions; and
a rate plate comprising one or more plate discharge openings, the rate plate being movable relative to the rate control gauge between a closed position and one of first and second open positions,
wherein the rate plate fully covers the one or more hopper discharge openings when the rate plate is in the closed position, and
wherein the rate plate abuts the stop and the one or more plate discharge openings is in at least partial registration with the one or more hopper discharge openings when the rate plate is in the first open position or the second open position.

10. The particle spreader of claim 9, wherein the one or more plate discharge openings has a first registration and a second registration with the one or more hopper discharge openings, wherein the first registration is 100 percent and associated with the rate plate being in the first open position, and wherein the second registration is less than 100 percent and associated with the rate plate being in the second open position.

11. The particle spreader of claim 10, wherein, when the stop is positioned at a second stop position of the series of stop positions and the rate plate is in the second open position, the one or more plate discharge openings has a second registration with the one or more hopper discharge openings, wherein the second registration is different than the first registration.

12. The particle spreader of claim 9, wherein the rate control gauge further comprises a locking device 326 configured to removably secure the stop to the gauge plate at one of the series of stop positions.

13. The particle spreader of claim 12, wherein the gauge plate includes a slotted opening, wherein the locking device 326 includes a fastener extending through the slotted opening, wherein the fastener removably couples to the stop to secure the stop in frictional engagement with the gauge plate.

14. The particle spreader of claim 13, wherein the fastener includes an adjustment knob 340 configured to be removably held in frictional engagement with the gauge plate or the stop.

15. The particle spreader of claim 9, further comprising a rate control lever operably associated with the rate plate, wherein the rate control lever is shiftable to move the rate plate between the closed position and one of the first open position and the second open position.

16. The particle spreader of claim 15, further comprising a linkage operably interconnecting the rate plate and the rate control lever.

17. The particle spreader of claim 9, wherein the rate control gauge and rate plate are operably connected by a spring biasing the rate plate toward the rate control gauge.

18. A method of operating a particle spreader with a rate control assembly, the method comprising:
shifting a rate plate between a closed position in which particles are held within a hopper and a first open position in which the particles are released through a discharge opening of the hopper at a first flow rate;
releasing a stop from a gauge plate;
moving the stop along the gauge plate from a first stop position to a second stop position;
releasably securing the stop to the gauge plate at the second stop position, and
shifting the rate plate between the closed position and the second open position in which the particles are released through the discharge opening of the hopper at the second flow rate.

19. The method of claim 18, further comprising shifting the rate plate away from the stop before releasing the stop from the gauge plate.

20. The method of claim 19, wherein the steps of shifting the rate plate between the closed position and the first open position and shifting the rate plate between the closed position and the second open position comprise:
pivoting a rate control lever operably associated with the rate plate in a first direction to shift the rate plate to the closed position; and
pivoting the rate control lever in a second direction to shift the rate plate to the first open position or the second open position.
